(19) United States
(12) Patent Application Publication
(10) Pub. No.: US 2012/0082910 A1
(43) Pub. Date: Apr. 5, 2012

(54) Carbon-based fuel cell system

(76) Inventor: Ronald David Brost, Whitefish, MT (US)

(21) Appl. No.: 13/251,275

(22) Filed: Oct. 2, 2011

Related U.S. Application Data
(60) Provisional application No. 61/404,399, filed on Oct. 4, 2010.

(51) Int. Cl. H01M 8/06

(52) U.S. Cl. 429/413; 429/423; 429/415

(57) ABSTRACT

An energy generation system includes a carbon reformer, an enthalpy wheel, and an electrochemical cell. The system allows production of electrical power using a variety of carbon-based fuels through a carbon monoxide intermediate and a means to isolate the carbon monoxide from waste products prior to injection into the fuel cell. The fuel cell oxidizes carbon monoxide and reduces oxygen spontaneously to develop electric current.

### CROSS REFERENCES TO RELATED APPLICATIONS

U.S. 61/404,399, US 2009/0023041 A1, U.S. Pat. No. 4,711,828

### STATEMENT REGARDING FEDERALLY SPONSORED RESEARCH OR DEVELOPMENT

No federally sponsored research was used in the development of this invention.

### TECHNICAL FIELD

The present disclosure relates to a fuel cell system that converts a carbon source to electrical energy through a carbon monoxide intermediate.

### BACKGROUND OF THE INVENTION

A commercially feasible direct carbon fuel cell that converts abundant carbonaceous materials such as coal directly to electrical power has been the ambition of many researchers for over a century (c.f. Cooper in US 2009/0023041 A1). The thermodynamics of the reaction

C(s)+O₂(g)→CO₂(g)

are very favorable, and due to the slightly positive entropy for the reaction, the theoretical electrical energy derived from such a cell may even exceed 100% of the enthalpy of reaction. Furthermore, if we consider carbon only and exclude the mass of oxygen and cell components, the specific energy of a carbon cell is about 9000 Wh/kg compared to lithium-air at 11000 Wh/kg and about 400 Wh/kg for the best lithium-ion cell. However, reality of cell construction reduces the specific energy of a cell that directly oxidizes carbon substantially to less than 15 Wh/kg versus 130 Wh/kg for lithium-ion. The multi-order-of-magnitude difference between the theoretical and practical achievement is due to several factors:
(a) The very unfavorable kinetics of the carbon oxidation and oxygen reduction requires temperatures in excess of 600° C. and high surface area catalysts for a reaction to proceed at a reasonable rate. This forces direct carbon fuel cell systems to include high-mass balance of plant components and operational energy to maintain temperature.
(b) The depolarization reaction is usually based on a very slow oxygen anion transport. In order to compensate for the slow anion diffusion, greater surface area is needed to maintain power at a useful level. The burden of higher interfacial area is counter to efficient cell design and results in a greater mass and volume overhead.
(c) The cumbersome mechanics of solids delivery systems, which involves hoppers and gravity feed, is not conducive to high surface area design. A lamellar plate arrangement with small distance between plates is preferred for efficient cell design, which is difficult to achieve with solids transport.
(d) High temperature operation (and losses to the environment) becomes an increasing energy penalty for small systems due to the scale of surface area to volume. This severely reduces the operational efficiency that is an inviolable requirement of these devices.
(e) Start-up times from ambient conditions are often long and require care to avoid fracture of ceramic separators. This is difficult to manage against the needs of the portable user, where immediate power is often required.

One area of particular success with fuel cell energy production is in the development of low-temperature hydrogen/air proton-exchange membrane fuel cells. Commercially-competitive high voltage stacks have been demonstrated with pilot-scale vehicle fleets that have completed several millions of miles of near-flawless operation based on this technology. Central to the operational success of the proton-exchange membrane fuel cell is the ability to use low-temperature (less than 100° C.) catalysts. The low-end operating temperature allows relatively fast and reliable start-ups even from frozen states and allows the use of polymeric membranes and inexpensive seals. In addition, the gaseous fuel and oxidant allows a very compact yet high surface area lamellar package, with a cell pitch of less than 1.5 mm.

An analogue to the hydrogen/oxygen fuel cell is the carbon monoxide/oxygen fuel cell. We may still presume a base carbon feedstock for the carbon monoxide cell since carbon monoxide may be derived from carbon oxidation, much as hydrogen may be generated from carbon through a water-gas shift reaction. A calculation based on thermodynamics and reasonable performance assumptions shown in FIG. 1 illustrates the characteristics of the three systems, all of which can derive from the same feedstock. Based on this analysis, the performance of a low-temperature carbon monoxide cell (where the carbon monoxide is reformed directly from carbon) is expected to be somewhat less than a theoretical direct carbon fuel cell, but compares favorably to the hydrogen fuel cell and is clearly better than internal combustion engine efficiency.

In order to react the carbon monoxide in an electrochemical cell, it required that carbon monoxide coordinate to a catalytic surface to initiate the reaction sequence that culminates in a release of electrons. It is known that carbon monoxide readily coordinates to many transition metals. For example, a patent filed by Hitachi (U.S. Pat. No. 4,711,828) teaches a homogeneous cuprous-carbonyl cycle that reacts water with the coordinated carbonyl to form carbon dioxide, protons, and reducing electrons that are exchanged through copper to an anode. The protons diffuse across the membrane to react with oxygen on the cathode to form water, which then returns to the anode to complete the cycle.

### BRIEF SUMMARY OF THE INVENTION

An energy generation system according to an embodiment of the present disclosure may include one or more cells that operate to generate energy through an electrochemical reaction between carbon monoxide and oxygen. The cell consists of an anode where the carbon monoxide is oxidized to carbon monoxide, a cathode where oxygen is reduced to water, and a separator disposed between the anode and the cathode that allows hydronium ion and water transfer between the anode and the cathode, yet prevents electrical shorting between the anode and the cathode. The system further includes a means of generating carbon monoxide by partial oxidation of a carbon source to carbon monoxide, which is then selectively removed from the product stream with an enthalpy wheel stripping unit and delivered to the previously described cell.

While exemplary embodiments are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a table of thermodynamic data that provides the theoretical basis for the disclosed invention, indicating probable effective efficiencies for the electrochemical reaction;

FIG. 2 is a schematic diagram of the fuel cell system showing the connections and arrangements of the system components;

FIG. 3 is an expanded view of a fuel cell;

FIG. 4 is a cross section of the reformer through the enthalpy wheel indicating how a reactor may be arranged with a device to absorb and desorb fuel gases.

### DETAILED DESCRIPTION OF THE INVENTION

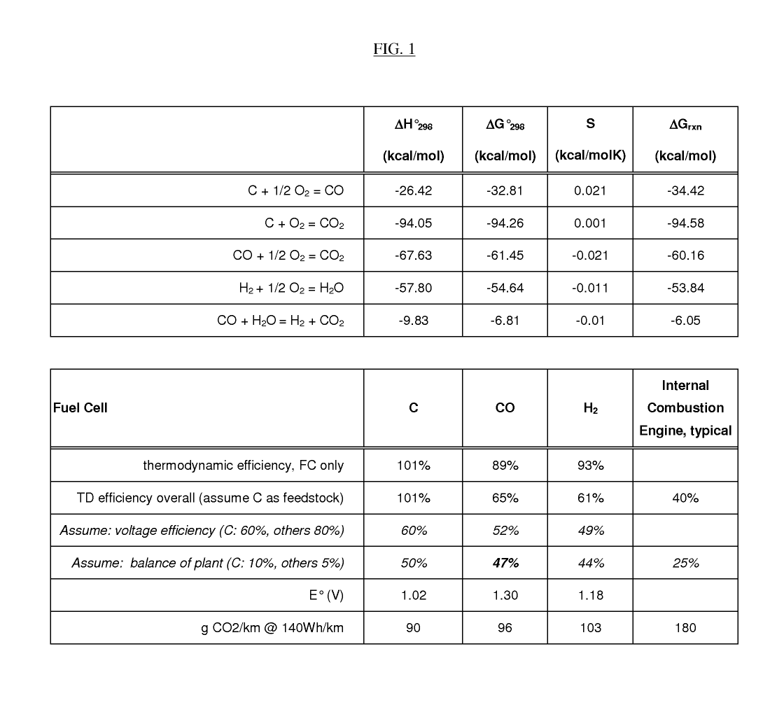

The present disclosure describes a configuration of an energy producing system. FIGS. 1 through 4 provide a detailed understanding of certain embodiments according to the present disclosure. In addition, embodiments may be practiced without one or more of the specific features explained in the following description.

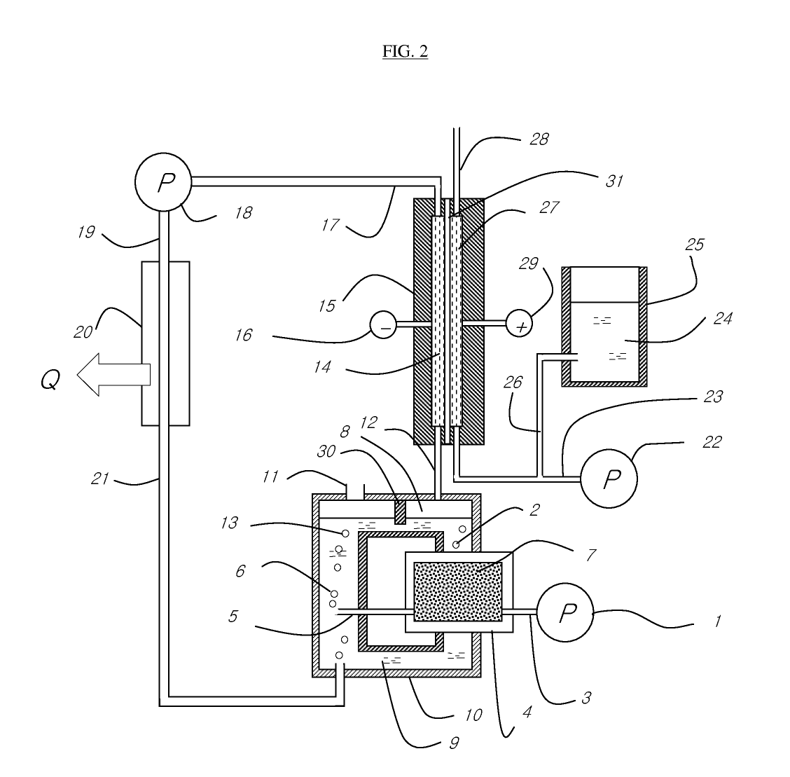

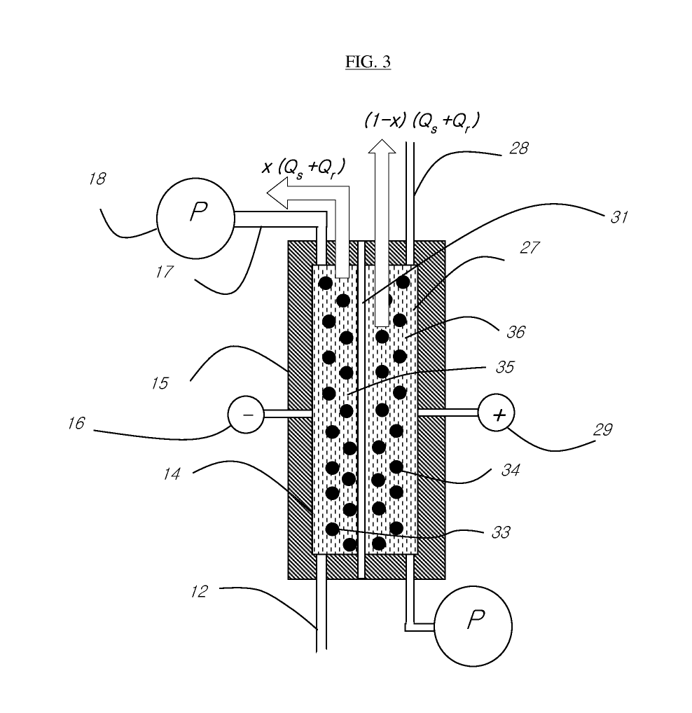

FIG. 2 shows an energy generation system that consists of an air pump 1 that pressurizes air from the atmosphere. The air is transported by pipe 3 to the carbon reformer 4, which includes a charge of carbon-based fuel 7. In reformer 4, the temperature and air feed is kept in such as state as to only partially oxidize the fuel 7 and so produce primarily carbon monoxide gas, but may contain water and trace amounts of carbon dioxide and other inert gases. This mix of gases are transported by pipe 5 to an enthalpy wheel 10 which consists of a toroidal vessel, a carbon monoxide absorbing fluid 9, a separating barrier 30, an off-gas port 11 to remove inert gases from the product stream, and a product port 12 that delivers desorbed carbon monoxide 6 to the fuel cell 15. Thermal desorption of carbon monoxide from fluid 9 is accomplished by applying the heat of reaction from the partial oxidation of fuel 7 to one side of the enthalpy wheel fluid that contains the absorbed carbon monoxide, whereby the carbon monoxide is released, collected in the upper reservoir 8 of the enthalpy wheel 10, and arranged to transport to fuel cell 15. The carbon monoxide thereby produced is forced by pressure differential by pump 18 through the fuel cell 15, whereupon the gas is oxidized to carbon dioxide. FIG. 3 illustrates the arrangements suggested to effect the oxidation of the carbon monoxide, which is initiated on catalytic surface 33. The anodic catalyst surface 33 may consist of platinum group metals such as platinum, iridium, and palladium in a finely dispersed or otherwise porous form which is then connected to a porous but conductive substrate 35 that provides physical support and electrical conduction between the catalytic surface 33 and the negative terminal 16, while still allowing free passage of gases and water. During this reaction, a heat of reaction Qₛ and inefficiencies of the electrical circuit increases the temperature of the anode flowing gases, which provides a mechanism for removing generated heat from the fuel cell as the gases exit the cell. Referring to FIG. 2, the unreacted and resulting hot anode product gases are transported by pump 18 through pipes 17 and 19 through a conventional heat exchanger 20 that serves to cool the gases through either convective or conductive means, removing heat Q. The resulting cooled gases are transported by pipe 21 back to the unheated side of the enthalpy wheel 10, where the fluid 9 is cooled by the incoming gas stream from pipe 21. Any unreacted carbon monoxide is absorbed in the cooler fluid and circulated by convection to the hot side of the enthalpy wheel 10, whereupon it is released as gas bubbles 2 and recirculated back to the fuel cell 15. Byproduct and inert gases 6 such as carbon dioxide and nitrogen are collected in a gas reservoir isolated from the carbon monoxide enriched headspace 8 by barrier 30 and thence removed through port 11. The cathode side of the fuel cell 15 may be of a conventional design, where air from the atmosphere is pressurized at pump 22 and transported through pipe 23 to the cathode side of fuel cell 15, whereupon the oxygen is electrochemically converted to water in an acid environment and accepts electrons provided by the anode balance of the circuit, thus providing the positive terminal 29. Unused oxygen and accompanying inert materials such as nitrogen are purged from the cell through pipe 28. An ion-selective membrane 31 is used to limit gas mixing between the anode and the cathode, yet allow depolarization of the electrodes by allowing ionic transport of hydronium ion. At option, it may be prudent for sustainable operation to provide a humidification source 24 consisting of water that is selectively injected through tube 26 to the tube 23, and thence into fuel cell 15, in order to humidify the membrane and maintain performance.

Such as device may be designed to provide a low temperature source of electrical power of approximately 2000 W for three hours with a charge of 1 kg of low ash-coal, which can be renewed continuously.

Complete single pass conversion of the carbon monoxide in fuel cell 15 is not necessary for efficient operation since bypass material will be reabsorbed in the recirculation loop provided by pump 18, pipe 19, and pipe 21.

Cooling of the fuel cell may take place with a separate cooling loop with a gaseous or liquid working fluid rather than heat transfer through the incumbent gases.

Low temperature catalysts suitable for carbon monoxide include various alloys and dispersed forms of the platinum-group metal family; for clarification this includes but is not limited to platinum, iridium, ruthenium, osmium, rhodium, and palladium. Similar catalysts are suitable for oxygen reduction on the cathode.

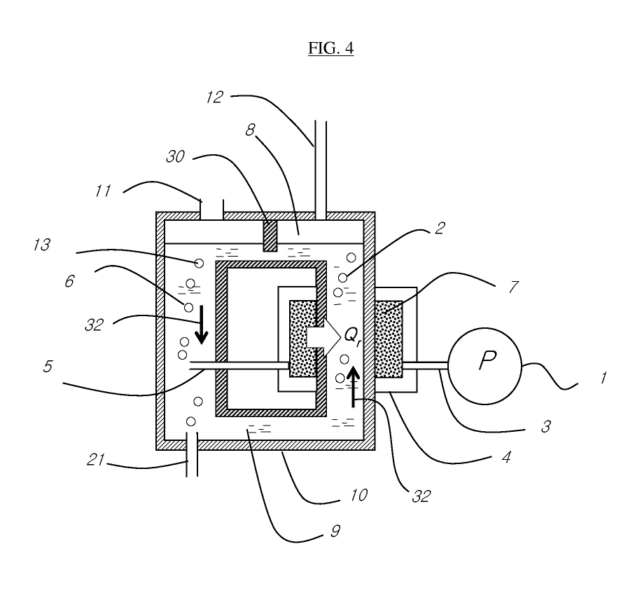

The enthalpy wheel is shown in FIG. 2 to function as a fluid circuit propelled by convective heating provided by the waste heat of the reformer 4. FIG. 4 further shows how this may be accomplished by completely or partially wrapping a fraction of the toroidal loop 10 with the reformer to effect heat transfer Qᵣ between the reformer and the enthalpy wheel. The heat transferred expands fluid 9 and reduces the density of same, causing it to rise in the vertical section of the enthalpy wheel. The induced flow as indicated by arrows 32 continues to the opposite side of the enthalpy wheel, where the effect of cooling fluid 9 due to direct contact with gases returning from pipe 21 further augments the circulation in the enthalpy wheel. This effect is promoted through a more pronounced vertical design to improve the convection.

Alternatively the fluid circuit of the enthalpy wheel may be propelled by active forced flow with a pump or other means to impart mechanical energy.

Materials suitable for carbon monoxide absorption fluid 9 may include carbonaceous slurries, but especially the chemical family of cuprous ammonium salts which are well-recognized for their ability to absorb and desorb carbon monoxide at various rates between 0° C. and 100° C. in aqueous solutions.

Pumps may be used to inject atmospheric air into the system, or an otherwise source of compressed air or compressed oxygen may be used.

With these exemplified arrangements, a specific energy on the order of 300 Wh/kg is achievable.

What is clamed is:

1. A system that is comprised of a carbon reformer, an enthalpy wheel that reversibly absorbs and desorbs carbon dioxide depending on the temperature of the absorbing fluid, and a fuel cell connected such that transfer of materials and energy is facilitated between the subsystems.

2. The system of claim 1 whereby a reservoir of a solid or liquid carbon source is partially oxidized to form carbon monoxide which is substantially extracted from the residual gases using a device consisting of an reversibly-absorbing fluid, a thermal gradient, a gas collection area, and a convectively circulating media.

3. The system of claim 1 whereby a reservoir of a solid or liquid carbon source is partially oxidized to form carbon monoxide which is substantially extracted from the residual gases using a device consisting of an reversibly-absorbing fluid, a thermal gradient, a gas collection area, and a forced circulating media.

4. The system of claim 1 whereby a moving stream of a solid or liquid carbon source is partially oxidized to form carbon monoxide which is substantially extracted from the residual gases.

5. The system of claim 1 whereby the heat derived from the partial oxidation of the carbon source is used to develop a thermal gradient which is then used to extract adsorbed carbon monoxide from the residual gases.

6. The system of claim 1 whereby the carbon monoxide is reacted with oxygen derived from air or another oxygen source in a proton exchange fuel cell reactor.

7. The system of claim 1 whereby a catalyst alloy based on the platinum-group metal family including platinum, iridium, ruthenium, osmium, rhodium, and palladium is used to oxidize carbon monoxide electrolytically at the anode.

8. The system of claim 1 whereby the oxidized carbon monoxide and unreacted carbon monoxide are recirculated to the enthalpy wheel for recovery of the unreacted carbon monoxide.

9. The system of claim 1 where the incoming oxygen gas stream is humidified by an external water source.
